(19) United States
(12) Patent Application Publication
(10) Pub. No.: US 2014/0176397 A1
(43) Pub. Date: Jun. 26, 2014

(54) DISPLAY DEVICE FOR A VEHICLE, AND A METHOD FOR OPERATING SUCH A DISPLAY DEVICE

(71) Applicants: Yanning Zhao, Burscheid (DE); Daniel Jendritza, Krefeld (DE); Frank Schliep, Leverkusen (DE)

(72) Inventors: Yanning Zhao, Burscheid (DE); Daniel Jendritza, Krefeld (DE); Frank Schliep, Leverkusen (DE)

(73) Assignee: Johnson Controls GmbH

(21) Appl. No.: 14/004,391

(22) PCT Filed: Mar. 9, 2012
(86) PCT No.: PCT/EP2012/054118

§ 371 Date: Dec. 19, 2013

(30) Foreign Application Priority Data
Mar. 11, 2011 (DE) 10 2011 013 628.2
Aug. 3, 2011 (DE) 10 2011 109 326.9
Dec. 12, 2011 (DE) 10 2011 088 278.2

(51) Int. Cl. G02B 27/01; G02B 27/48

(52) U.S. Cl. CPC G02B 27/01; G02B 27/48
USPC 345/7

(57) ABSTRACT

A display device for a vehicle displays image information that can be seen by at least one vehicle occupant. A lighting unit and a display unit are provided, the lighting unit being designed as at least one laser, and at least some sections of the display unit being formed from at least one electro-active polymer and/or from a chromogenic material. A method is also provided for operating a display device.

### CROSS REFERENCE TO RELATED APPLICATIONS

The present application is a U.S. National Stage of International Application No. PCT/EP2012/054118 filed on Mar. 9, 2012, which claims the benefit of German Patent Application No. 10 2011013 628.2 filed on Mar. 11, 2011, German Patent Application No. 10 2011 109 326.9 filed on Aug. 3, 2011, and German Patent Application No. 10 2011 088 278.2 filed on Dec. 12, 2011 the entire disclosures of all of which are incorporated herein by reference.

The invention relates to a display device for a vehicle according to the preamble of patent claim 1. Furthermore, the invention relates to a method for operating such a display device according to the preamble of patent claim 8.

Display devices for a vehicle, for example in the form of so-called head-up displays are already known. In order to project bright images onto a display unit of a display device for a vehicle with a wide color spectrum and contrast, lasers are particularly well suited as lighting unit on account of their high optical efficiency. It is known here that, on account of the coherence of a laser beam, a so-called speckle pattern occurs as image noise, this giving the impression of granularity that covers the image. The speckle pattern results from the interference of coherent beams which are diffusely reflected from an optically rough surface of the display unit and transmitted and subsequently captured by a detector having a finite aperture, for example the human eye. This applies both to display devices for front projection, i.e. for viewing an image of the light backscattered from the display unit, and in back projection, i.e. for image viewing in the transmission of an image projected onto the rear side of the display unit.

Various approaches are known for reducing and/or avoiding the speckle pattern in images of a display device. By way of example, U.S. Pat. No. 7,796,330 B2 proposes reducing the speckle pattern by means of two display devices that are moveable relative to one another. U.S. Pat. No. 7,762,673 B2 and U.S. Pat. No. 7,585,078 B2 propose splitting a laser beam into two partial beams by means of optical aids and thus reducing the temporal and spatial coherence of the laser beam. U.S. Pat. No. 7,535,937 B2 provides for extending a laser beam for projecting images onto a display device by means of combination of intra-cavity radiation and mixing of different frequencies.

Furthermore DE 20 2004 020 615 U1 describes a screen for projecting laser light, comprising at least one layer transparent to laser light and at least one layer that reflects the laser light, wherein the reflective layer is designed to be flexible and the transparent layer has a higher stiffness relative to the reflective layer, wherein the screen furthermore comprises at least one piezoelectric element or/and at least one element which generates electrostatic forces, and with which at least the surface structure of the reflective layer can be varied over time by the bending of the reflective layer during the projection process in such a way that a laser light beam that penetrates through the transparent layer and impinges on a point of the reflective layer is reflectable in different directions depending on a time function.

It is an object of the present invention to specify, by comparison with the prior art, an improved display device for a vehicle and an improved method for operating a display device in a vehicle.

With regard to the display device for a vehicle, the object is achieved by means of the features specified in claim 1.

With regard to the method for operating a display device in a vehicle, the object is achieved by means of the features specified in claim 8.

The dependent claims relate to advantageous developments of the invention.

In the display device for a vehicle for representing image information that can be seen by at least one vehicle occupant according to the invention a lighting unit and a display unit are provided, wherein the lighting unit is designed as at least one laser, and at least some sections of the display unit are formed from at least one electroactive polymer and/or from a chromogenic material.

By means of the use of such a chromogenic material and/or electroactive polymer for the display unit in conjunction with an active control of a transparency, i.e. the light transmissivity, for sections of the display unit of chromogenic material and/or an active control of the change in shape and the modulation frequencies thereof or the resultant movement of the display unit or of sections of the display unit of electroactive polymer and also the use of different modulation frequencies of a radiation generated by the lighting unit, it is thus possible to reduce a coherence of the radiation which is reflected and/or transmitted by a surface of the display unit, with the result that it is possible to reduce interference patterns in particular speckle patterns, which have a disturbing effect on an image quality, in the image representation.

The chromogenic material comprises electrically activatable and/or non-electrically activatable components. Examples of suitable electrically activatable components include so-called SPDs (suspended particle devices), electrochromes, micro-diaphragms or other corresponding types of liquid crystals. Non-electrically activatable components comprise, for example, thermochromic, thermotropic, gasochromic or photochromic components. Preferably, the chromogenic material is designed as a multilayer arrangement, whereby a transparency of the image cells of chromogenic material is controllable time-sequentially.

In one preferred embodiment of the invention, subsections of the display unit are formed from at least one electroactive polymer and/or can be caused to vibrate in a translational and/or rotational direction.

By means of the use of some sections of such an electroactive polymer for the display unit in conjunction with an active control of the change of shape and the modulation frequencies thereof or the resultant translational and/or rotational movement of the display unit or sections of the display unit and the use of different modulation frequencies of a radiation generated by the lighting unit, it is thus possible to reduce the coherence of the radiation reflected and/or transmitted by the display unit.

In this case, the electroactive polymer is preferably designed as an electrostrictive dielectric, ferroelectric or as a liquid-crystal-based polymer. Electroactive polymers are polymers which change their shape as a result of an electrical voltage being applied.

Preferably, a change in a shape of the electroactive polymer and a resultant translational and/or rotational movement of the display unit is controllable and/or regulatable by the application of a voltage.

In an alternative embodiment variant, the entire display unit can be formed from chromogenic material or from at least one electroactive polymer.

Particularly preferably, electrodes for coupling to a voltage source are arranged on the display unit marginally, in particular outside a region that can be seen by the vehicle occupant. As a result, a representation quality of the display unit is unimpaired and uninfluenced by the contact-connection of the display unit.

In the method for operating a display device, according to the invention a transparency at least of sections of the display unit of chromogenic material is controlled and/or regulated and/or sections of the display unit of electroactive polymer are caused to vibrate in a translational and/or rotational direction and/or a lighting unit designed as laser is operated in a frequency-modulated or phase-modulated manner. It is thereby possible to reduce a coherence of the radiation which is reflected and/or transmitted by a surface of the display unit, thus making it possible to reduce interference patterns in particular speckle patterns which have a disturbing effect on an image quality, in the image representation.

In one preferred embodiment the display unit is caused to vibrate in a translational and/or rotational direction by the application of an electrical voltage to the electroactive polymer and in a resultant change in shape thereof.

The invention is explained in greater detail with reference to the accompanying figures.

In the figures:

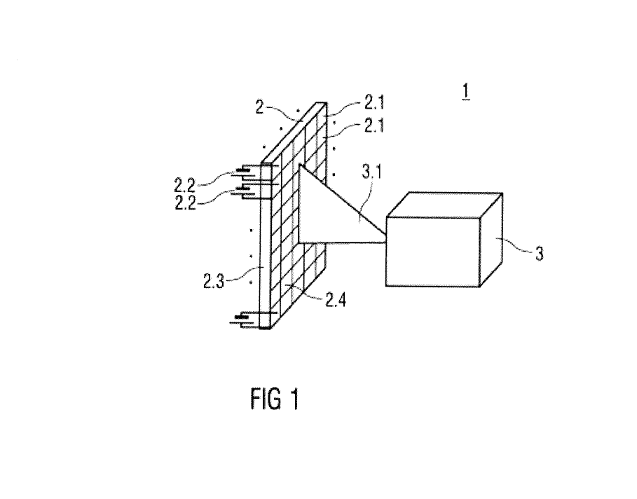

FIG. 1 schematically shows a perspective illustration of a first embodiment variant of a display device,

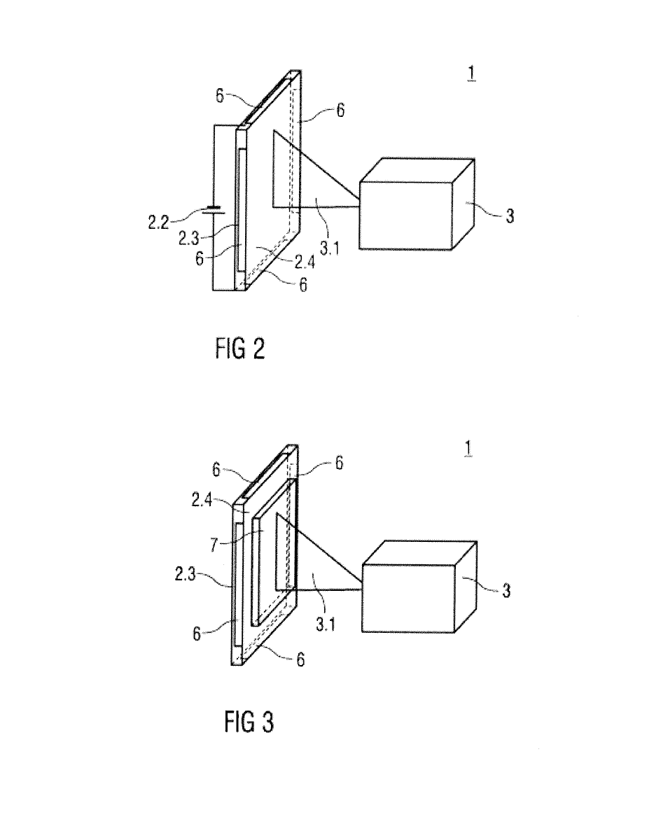

FIG. 2 schematically shows a perspective illustration of a second embodiment variant of a display device,

FIG. 3 schematically shows a perspective illustration of a third embodiment variant of a display device,

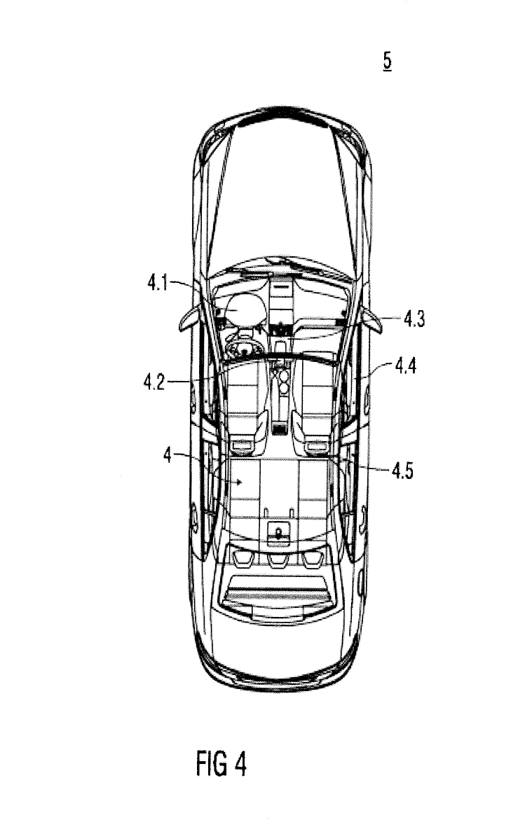

FIG. 4 schematically shows a plan view of a vehicle in semitransparent illustration.

Mutually corresponding parts are provided with the same reference signs in all the figures.

FIG. 1 schematically shows a perspective illustration of a first embodiment variant of the display device 1. In this case, the display device 1 comprises a display unit 2 and a lighting unit 3.

The display unit 2 comprises a multiplicity of image cells 2.1 arranged in grid-type fashion, which are electrically drivable in each case by an energy source 2.2, in particular voltage source, in the present exemplary embodiment.

The display unit 2 furthermore has a front side 2.3 (not illustrated more specifically) and a rear side 2.4, wherein the front side 2.3 faces an observer and the rear side 2.4 faces the lighting unit 3.

Both the front side 2.3 and the rear side 2.4 of the display unit 2 have a rough surface in a manner governed by production.

The lighting unit 3 is designed as at least one laser, for example semiconductor laser, and generates a radiation 3.1 in a visible range with a defined wavelength, which impinges on the rear side 2.4 of the display unit 2 and is both partly reflected and partly transmitted by the surface of the rear side 2.4, as a result of which a corresponding image can be represented for an observer on the front side 2.3 of the display unit 2.

In this case, the lighting unit 3 and/or the radiation 3.1 engaging from same can be frequency- or alternatively phase-modulated in a conventional manner in order to avoid or destroy a temporal coherence of the emitted radiation 2.1 and to extend a line width of an emitted light beam.

In this case, a modulation of the emitted radiation 3.1 can be effected directly or indirectly. In the case of direct modulation, the light from the laser is modulated directly, preferably by means of a corresponding regulation and/or control of a supply current.

In the case of indirect modulation, a modulation unit is disposed downstream of the laser and modulates the emitted radiation 3.1. In this case, an indirect modulation can be effected as electro-optical modulation or as acousto-optical modulation.

In the case of electro-modulation, the polarization properties of a light beam are periodically altered, for example by means of corresponding filters.

In the case of acousto-optical modulation, the light beam is diffracted at ultrasonic waves and modulated in this way.

In an embodiment variant which is not illustrated, image projection directly onto the front side of the display unit 2 can be effected.

In accordance with the first embodiment variant of the invention, at least some sections of the display unit 2 are formed from a chromogenic material.

In this case, either individual image cells 2.1 of the display unit 2 or grids of image cells 2.2 or all the image cells 2.1 of the display unit 2 can be formed from chromogenic material.

Chromogenic materials are colorant-forming materials which change their optical behavior, in particular an optical transparency, depending on an external stimulus such as temperature (theromochromism) light (photochromism), pressure (piezochromism), electrical voltage (electrochromism) etc. The change can take place reversibly or irreversibly.

For this purpose, the chromogenic material can contain electrically activatable components such as, for example, so-called SPDs (suspended particle devices), electrochromes, micro-diaphragms or other corresponding types of liquid crystals, and non-electrically activatable components such as, for example, thermochromic, thermotropic, gasochromic or photochromic components.

In this case, the chromogenic material of the display unit 2 crucially influences the image which is to be represented on the front side 2.3 of the display unit 2 and in which said material forms a corresponding colorant depending on the stimulus, here the radiation 3.1.

Preferably, the image cells 2.1 of chromogenic material have a plurality of layers of the chromogenic material, wherein the temperature of the individual layers can be changed time-sequentially depending on the radiation 3.1 impinging on them.

In other words, depending on the layer on which the radiation 3.1 impinges, the optical transparency of the layer changes as a result of colorant formation.

By means of the use of such a chromogenic material for the display unit 2 in conjunction with an active control of the transparency of the image cells 2.1, in particular image cells 2.1 of chromogenic material, and the use of different modulation frequencies of the radiation 3.1 generated by the lighting unit 3, it is thus possible to significantly reduce a coherence of the reflected and transmitted radiation 3.1.

As a result, it is possible to reduce instances of interference, in particular a so-called speckle pattern, which have a disturbing effect on an image quality. Speckled patterns are granular interference phenomena which occur in the event of sufficiently coherent illumination of optically rough surfaces.

Consequently, both the lighting unit 3 and the display unit 2 constitute active components of the display device 1 for representing an image on the front side 2.3 of the display unit 2.

FIG. 2 schematically shows a perspective illustration of a second embodiment variant of the display device 1.

At least some sections of the display unit 2 are preferably formed from at least one electroactive polymer.

Electroactive polymers are polymers which change their shape as a result of an electrical voltage being applied. In this case, the electroactive polymers can be designed as electrostrictive, dielectric, ferroelectric or as liquid-crystal-based polymers.

By producing at least some sections of the display unit 2 from at least one electroactive polymer, it is possible for said display unit to be caused to vibrate in a translational and/or rotational direction as a result of the change in shape of the electroactive polymer. In this case, movements with specific patterns, e.g. sinusoidal, are also possible. In order to bring about said change in shape, a voltage from an energy source 2.2 can be applied to the display unit 2.

In order to couple the electroactive polymer of the display unit 2 to the energy source 2.2, for example conventional electrodes 6 are arranged on the display unit 2 marginally.

In this case, the entire display unit 2 can consist of electroactive polymer, or sections of electroactive polymer are arranged on the display unit 2 marginally, for example. This makes it possible to save material and thus costs.

In this case, the electroactive polymer of the display unit 2 crucially influences the image to be represented on the front side of the display unit 2 by virtue of said polymer causing the display unit or at least sections of the display unit to vibrate in a translational and/or rotational direction, depending on the stimulus.

By means of the use of such an electroactive polymer for the display unit 2 in conjunction with an active control of the change in shape of the electroactive polymer and the modulation frequencies thereof and thus the resultant movement of the display unit 2 or of sections of the display unit 2 and the use of different modulation frequencies of a radiation 3.1 generated by the lighting unit 3, it is thus possible to reduce a coherence of the radiation which is reflected and/or transmitted by the front side 2.3 of the display unit 2, thus making it possible to reduce speckled patterns in the image.

Furthermore, it is possible for some sections of the display unit 2 to be formed from chromogenic material and for some sections of said display unit to be formed from at least one electroactive polymer.

FIG. 3 schematically shows a perspective illustration of a third embodiment variant of the display device 1. In this case, the embodiment variant according to FIG. 3 substantially corresponds to the embodiment variant according to FIG. 2 with the difference that a diffuser or diffusing screen 7 is arranged at the rear side 2.4 of the display unit 2 and diffuses and homogenizes the impinging radiation 3.1 from the lighting unit 3 in order to make hard direct light radiation softer and to reduce extreme light-shadow contrasts and disturbing reflections.

FIG. 4 shows a conventional vehicle interior 4 of a vehicle 5 illustrated in a semitransparent fashion.

In the vehicle interior 4, the display device 1 according to the invention can be arranged for example in an instrument panel 4.1, a roof console 4.2, a center console 4.3 a door trim 4.4 and/or a headrest 4.5 in order to represent an image and serves, for example for the display of diverse information relevant to the vehicle and/or the entertainment of vehicle occupants.

### LIST OF REFERENCE SIGNS

1 Display device
2 Display unit
2.1 Image cells
2.2 Energy source
2.3 Front side
2.4 Rear side
3 Lighting unit
3.1 Radiation
3.1 Vehicle interior
4.1 Instrument panel
4.2 Roof console
4.3 Centre console
4.4 Door trim
4.5 Headrest
5 Vehicle
6 Electrodes
7 Diffuser

1. A display device for a vehicle for representing image information that can be seen by at least one vehicle occupant, the display device comprising:
a lighting unit; and
a display unit,
wherein the lighting unit is designed as at least one laser, and at least some sections of the display unit are formed from at least one of at least one electroactive polymer and a chromogenic material.

2. The display device as claimed in claim 1, wherein the chromogenic material comprises at least one of electrically activatable and non-electrically activatable components.

3. The display device as claimed in claim 1, wherein some sections of the display unit can be caused to vibrate in at least one translational direction.

4. The display device as claimed in claim 1, wherein the electroactive polymer is designed as an electrostrictive dielectric, ferroelectric or as a liquid-crystal-based polymer.

5. The display device as claimed in claim 1, wherein a change in a shape of the electroactive polymer and a resultant at least one of translational and rotational movement of the display unit is at least one of controllable and regulatable by the application of a voltage.

6. The display device as claimed in claim 1, wherein the entire display unit is formed from chromogenic material or electroactive polymer.

7. The display device as claimed in claim 1, wherein electrodes for coupling to an energy source are arranged marginally on the display unit.

8. A method for operating a display device as claimed in claim 1, wherein the at least one of:
a transparency at least of sections of the display unit of chromogenic material is at least one of controlled and regulated,
sections of the display unit of electroactive polymer are caused to vibrate in at least one of a translational and rotational direction, and
a lighting unit designed as laser is operated in a frequency-modulated or phase-modulated manner.

9. The method as claimed in claim 9, wherein the display unit is caused to vibrate in at least one of a translational and rotational direction by the application of an electrical voltage to the electroactive polymer and in a resultant change in shape thereof.
